(19) United States
(12) Patent Application Publication
(10) Pub. No.: US 2013/0280397 A1
(43) Pub. Date: Oct. 24, 2013

(54) SYSTEM AND METHOD FOR PREPARING FOOD

(71) Applicants: Tom Ryan, Cherry Hills Village, CO (US); David J. Biederman, Greenwood Village, CO (US); Andrew J. Selvaggio, Evergreen, CO (US)

(72) Inventors: Tom Ryan, Cherry Hills Village, CO (US); David J. Biederman, Greenwood Village, CO (US); Andrew J. Selvaggio, Evergreen, CO (US)

(21) Appl. No.: 13/861,204

(22) Filed: Apr. 11, 2013

Related U.S. Application Data
(60) Provisional application No. 61/622,839, filed on Apr. 11, 2012.

(51) Int. Cl. A22C 7/00

(52) U.S. Cl. CPC A22C 7/0076
USPC 426/513; 426/512; 99/426

(57) ABSTRACT

A system and method of food preparation is provided. A tool for manipulating and shaping food products, such as ground meats, is provided with specific structural features for applying a force to a raw food product. Methods of using the same are provided.

This Non-Provisional Application claims the benefit of priority from U.S. Provisional Patent Application 61/622,839 filed Apr. 11, 2012, the entire disclosure of which is hereby incorporated by reference in its entirety.

### FIELD

The present disclosure relates generally to systems, devices, and methods for preparing food. Specifically, devices and methods are contemplated for processing, handling, and/or cooking various meats and similar products.

### BACKGROUND

Conventional devices, methods and systems for preparing food in patty form suffer from various drawbacks. Certain drawbacks of such devices, methods and systems relate to balancing the interest of thoroughly cooking the food product without overcooking, drying, or reducing the product to an unnecessary extent. Open flame or heat sources, such as grills, pose risks of withdrawing excessive juice and fat from such a product. There has been a long-felt and unmet need to provide devices, methods and systems for quickly and efficiently cooking food products with a reliable final internal temperature without suffering from these noted drawbacks.

### SUMMARY

Accordingly, the present disclosure contemplates a novel method, system and devices for preparing food products. In various embodiments, devices and methods are provided that are specifically adapted for preparing food in patty form, such as burgers. It will be noted, however, that as used herein the term “burger” is not limited to beef or any specific burger. Indeed, it is contemplated that patties or burgers as used herein comprise beef, turkey, bean-based, tofu, soy, fish (e.g. salmon), chicken, and similar products whether currently known or developed hereafter.

According to this disclosure, a method of food preparation can provide gently processed ground beef, such as certified Angus beef. The beef, or similar source product, is provided in bulk form, such as a five-pound bag or any quantity that generally comprises multiple servings of the product. The bulk form of the product is separated by forming individual serving portions, which may be in the form of balls or substantially spherical portions, comprising a predetermined weight and/or volume. By way of example, the bulk form product may be formed into 3.2 ounce, 5 ounce, and/or 7 ounce units, such as may generally correspond to small, medium and large portion sizes for a finished product. The serving-sized portions may then be stored in a refrigerated manner until cooking is desired. Typically, a moisture content of the bulk form product ranges from about 55 to about 65 percent.

Different cooking surfaces can be employed to cook the serving-sized portion of product. Commonly, a broad, flat surface such as a flat grill or griddle is provided as the heat source and cooking surface. Alternatively, grate grills, pans, and other cooking surfaces suitable for heating and cooking a patty-style food product can be utilized. A contemplated method of preparing the food product comprises applying butter, cooking oil, or similar lubricious materials suitable for cooking to the cooking surface. The serving-sized product is then placed on the portion of the cooking surface to which the lubricious material is applied. The product is then partially formed and compressed via a tool, such as the tools shown and described herein. One or more layers of parchment paper or a similar barrier can be provided between the tool and the food product.

Food processing tools of the present disclosure can provide various benefits, including shaping the food product generally to a desired size and shape, and exerting pressure between the food product and the cook surface. Such pressure, particularly in the presence of a butter or oil layer, facilitates a sear on one or more sides of the food product which facilitates preservation of liquids, fats, and favors inherent in the meat (or similar). Tools of the present disclosure can decrease required cook time of the product by exerting pressure and forming a preferred geometry of the product, but further lock-in desired contents of the product, thus obviating various issues with the prior art where one of flavor and safe cook time are typically sacrificed for the other. Additionally, methods and devices of the present disclosure can enable a cohesive burger that has at least exterior structural integrity and does not disassociate during subsequent food processing operations.

Methods and devices of the present disclosure can enable a cook time of approximately three minutes for a seven ounce beef patty as opposed to at least seven minutes as required by various prior art methods and devices.

In at least one embodiment, a method of preparing a food product is provided, the method comprising forming a plurality of food product units from a single source, each of said plurality of food product units comprising at least one of a predetermined volume and a predetermined weight and based on an input request, selecting at least one of the plurality of food product units, applying at least one of a flavoring and a lubricating substance on an area of a heated surface, placing said at least one of the plurality of food product units on the area, providing an apparatus for handling food product such as those shown and described herein, placing the apparatus in contact with the at least one of the plurality of food product units, applying a force to the handle portion and deforming the at least one of the plurality of food product units until the food product unit contacts substantially the entirety of the planar member and the at least one sidewall portion, allowing a first amount of time to lapse, rotating the at least one of the plurality of food product units approximately 180 degrees, allowing a second amount of time to elapse, and removing the at least one of the plurality of food product units from the area.

Embodiments of the present disclosure can provide various other benefits over the prior art, including, for example, a decreased time for safe cooking of meat and food products, preservation of flavors within said meat—a feature typically sacrificed in the interest of thorough cooking, and a food texture and substance that is tender, juicy, soft, and generally pleasing to the consumer. A shorter cook time can not only preserve the natural flavor of the meat but also provide a smaller required cook surface area to service a selected number of customers, thereby providing for a substantially lower operating cost and consequently higher level of profitability for the food service facility.

Devices and methods of the present disclosure can provide for searing, and thus sealing fat and liquids within the food product. Such devices and methods can prevent significant losses of fat and desirable liquids as compared with prior art devices. Accordingly, with such little fat loss, the present disclosure can enable of the use of leaner product(s) as the initial stock material while still delivering a final or cooked product that is of desirable fattiness and juiciness. In certain embodiments, 80/20 beef/fat content is provided as an original or source material.

These and other advantages will be apparent from the disclosure of the aspects, embodiments, and configurations contained herein.

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

As used herein, the term “meat” is contemplated as being inclusive of beef, pork, fish, poultries, and meat-like products such as vegetable, soy and bean based products.

These and other advantages will be apparent from the disclosure contained herein. The above-described aspects, embodiments, objectives, and configurations are neither complete nor exhaustive. As will be appreciated, other aspects and embodiments of the disclosure are possible using, alone or in combination, one or more of the features set forth above or described in detail below. Further, the summary of the disclosure is neither intended nor should it be construed as being representative of the full extent and scope of the present disclosure. The present disclosure is set forth in various levels of detail in the summary of the disclosure, as well as, in the attached drawings and the detailed description of the disclosure and no limitation as to the scope of the present disclosure is intended to either the inclusion or non-inclusion of elements, components, etc. in this summary of the disclosure. Additional aspects of the present disclosure will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1 is a bottom perspective view of one embodiment of a food preparation tool according to the present disclosure;

FIG. 2 is a top plan view of one embodiment of a food preparation tool according to the present disclosure;

FIG. 3 is a front elevation view of one embodiment of a food preparation tool according to the present disclosure;

FIG. 4 is a left elevation view of one embodiment of a food preparation tool according to the present disclosure; and

FIG. 5 is a flow chart illustrating a food preparation method according to one embodiment.

### DETAILED DESCRIPTION OF THE DRAWINGS

The present disclosure can have significant benefits across a broad spectrum of endeavors. It is the applicant's intent that this specification and the claims appended hereto be accorded a breadth in keeping with the scope and spirit of the disclosure despite what might appear to be limiting language imposed by the requirements of referring to the specific examples disclosed. To acquaint persons skilled in the pertinent arts most closely related to the present disclosure, an enabling embodiment of the method that, in some applications, illustrates a preferred mode now contemplated for putting the disclosure into practice is described herein by, and with reference to, the annexed drawings that form a part of the specification. The exemplary method is described in detail without attempting to describe all of the various forms and modifications in which the disclosure might be embodied. As such, the embodiments described herein are illustrative, and as will become apparent to those skilled in the arts, can be modified in numerous ways within the scope and spirit of the disclosure.

The detailed description is to be construed as exemplary only and does not describe every possible embodiment since describing every possible embodiment would be impractical, if not impossible. Numerous alternative embodiments could be implemented, using either current technology or technology developed after the filing date of this patent.

To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

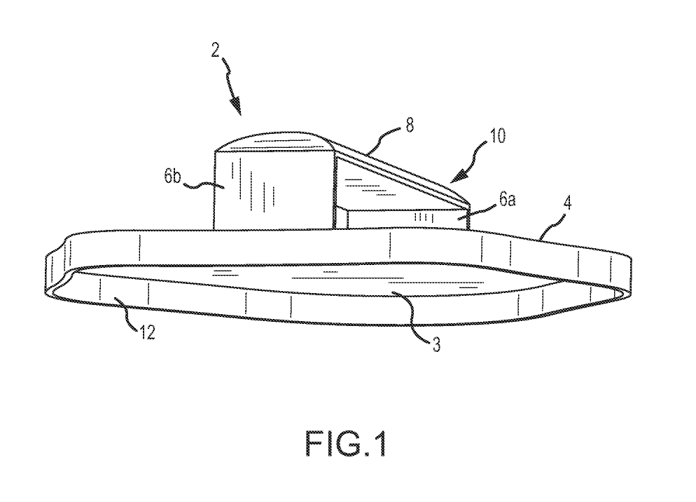

FIG. 1 is a bottom perspective view of a food preparation tool 2 according to one embodiment of the present disclosure. As shown, the tool 2 comprises a handle 10 for grasping by a user and for manipulating the tool 2. The handle 10 comprises a user-grasping portion 8 and downwardly extending support members 6a, 6b. The handle 10 is interconnected to a body portion 4 via support members 6a, 6b. Such interconnection may be accomplished through various methods and devices, including, but not limited to tack welds, fasteners, etc. The body portion 4 comprises peripheral side walls 12 extending around a perimeter of the body portion 4. The side walls 12 at least partially define a void space 3 within the body portion 4. The void space 3 generally corresponds to a desired shape of a food product after interaction with the tool 2.

In the depicted embodiment, the body portion 4 comprises a curvilinear perimeter with multiple points of inflection and comprising a substantially five-point or five-node shape. Such a shape is provided to provide a desirable, irregular final shape to a food product. It will be recognized, however, that the present disclosure is not limited to any particular shape in this regard. Indeed, it is contemplated that the body portion 4 comprises various alternative shapes including, but not limited to, round, rectangular, square, etc.

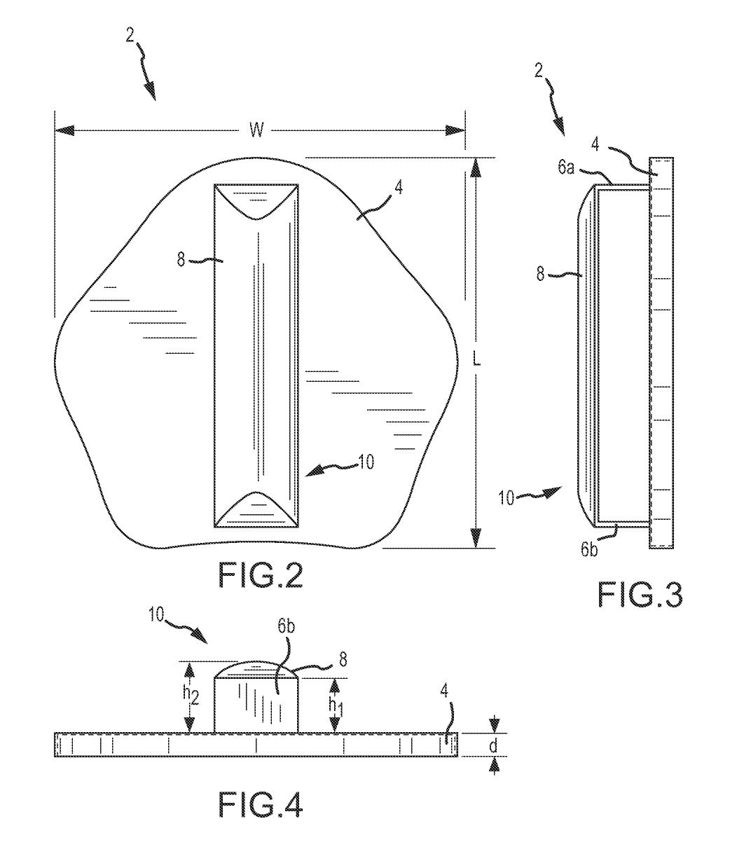

FIG. 2 is a top plan view of the embodiment of FIG. 1 showing the tool 2, body portion 4, and user-grasping portion 8. Also depicted is the length L and width W dimensions of the tool 2. The body portion 4 and void space 3 defined therein comprises a volume for use with a specific volume of food to be prepared. Accordingly, in various embodiments, tools 2 are provided and sized so as to work with specific sized food products (e.g. 3.2 oz., 5 oz., and 7 oz. patties). Accordingly, the length L, width W and depth of the tool 2 will vary based on desired patty size. In various embodiments, a tool 2 is provided with a width W between approximately 5 inches and approximately 8 inches. In preferred embodiments, a tool 2 is provided with a width W between approximately 5.950 inches and 6.875 inches. In various embodiments, a tool 2 is provided with a length L between approximately 4 inches and approximately 7 inches. In particular embodiments, tools 2 are provided with a length L of between approximately 4.625 inches and approximately 6.125 inches.

FIG. 3 is a front elevation view of the embodiment of FIG. 2 showing the tool 2, main body portion 4, and handle 10. As shown, the user-grasping portion 8 of the handle 10 comprises a generally convex shape and a thickness. As shown and described herein, a thickness of the portion 8 is provided to enable sufficient force to be transmitted to food products and prevent substantial and/or permanent deformation of the handle.

FIG. 4 is a left elevation view of the embodiment shown in FIGS. 1-3. As shown, the tool 2 comprises a main body portion 4 having a depth d. An internal volume of the void space 3 will be dependent upon the length L, width, W and depth d of the main body portion 4, as well as the circumference of the main body portion 4. A resultant depth or thickness of a food product for use with the tool 2 will generally correspond to the depth d of the tool 2. In various embodiments, a tool 2 is provided with a depth “d” between approximately 0.300 inches and approximately 0.500 inches. In preferred embodiments, a tool 2 is provided with a depth “d” between approximately 0.350 inches and approximately 0.425 inches.

As further shown in FIG. 4, the handle 10 comprises a user grasping potion 8 and downwardly extending support members 6b. Support members 6a, 6b comprise a height “h₁” extending above the main body portion 4. In various embodiments, height “h₁” comprises a height between approximately 1.00 inch and approximately 4.00 inches. In certain embodiments, height “h₁” comprises a height between approximately 1.50 inches and approximately 2.25 inches. In a preferred embodiment, height “h₁” comprises a height of approximately 1.90 inches. In various embodiments, height “h₂” comprises a height between approximately 1.50 inches and approximately 4.50 inches. In certain embodiments, height “h₂” comprises a height between approximately 1.75 inches and approximately 2.50 inches. In a preferred embodiment, height “h₂” comprises a height of approximately 2.25 inches. Thus, in at least one embodiment, a maximum handle thickness of approximately 0.35 inches is provided.

As will be recognized, a user-applied force to a handle 10 will result in a bending moment being applied to the user grasping portion 8. Generally, this user portion 8 will operate as a beam to resist the user-applied shear force perpendicular to the longitudinal axis of the beam and transmit force to the food product. The beam 8 is supported at two ends by the downwardly extending members 6a, 6b. Where a standard force f is applied along the length of the portion 8, the beam 8 has a support reaction wherein the shear forces at either end of the beam 8 are characterized by:

Fₛ=fL/2

wherein Fₛ is the shear force at each end of the beam 8, f is the distributed force and L is the length of the beam. The shear force at any other point along the beam other than the end points is characterized by the following relationship:

F(x)=Fₛ−fx=(fL/2)−fx=f(L/2−x)

wherein x is the distance from one end of the beam. The bending moment M at any point along the beam is equal to the area under the shear force diagram up to that point. The maximum bending moment M will thus occur in the center of the beam 8, at a point substantially equidistant from the ends.

Under known Euler-Bernoulli bending theory, the moment of such a simple beam 8 can be analyzed. It is known, for example, that constant cross-section beams can be analyzed using

σ=yqL²/8I

where α is the maximum stress of the beam, y is the perpendicular distance from the neutral axis, q is the uniform load per length unit, L is the length of the beam, and I is the moment of inertia. The moment of inertia I is a function of an object's shape.

In embodiments wherein the handle portion comprises a beam member of constant rectangular cross-section, the moment of inertia of such a handle is characterized by

I=bh³/12

where b is the width of the beam and h is the height. Accordingly, a handle comprising a width of approximately 1.500 inches and a height of approximately 0.125 inches would have a moment of inertia I of approximately 0.000244 inches⁴. Solving for the maximum deflection of such a beam wherein the beam comprises stainless steel with a modulus of elasticity of approximately 30*10⁶ psi and approximately 50 pounds of force applied to the handle results in a theoretical maximum deflection of approximately 0.016 inches. Such a deflection is known to be well within the plastic deformation limit of such a steel handle and considered acceptable for food preparation purposes. Reducing the thickness of the beam in the foregoing example to approximately 0.0625 inches reduces the moment of inertia I of such a handle to approximately 0.000031 inches⁴. Such a change results in the theoretical deflection of the beam increasing to approximately 0.13 inches. Similarly, an increase in the handle thickness to approximately 0.25 inches results in an increase in the moment of inertia I and a decrease in the theoretical deflection to approximately 0.00196 inches. It will be recognized, therefore, that beam thickness is a critical consideration. A theoretical deflection of 0.13 inches may be acceptable for certain applications. The effects of cyclic loading of the beam must also be considered, as food preparation tools of the present disclosure are contemplated as being used as many as hundreds of times per day.

The effects of cyclic loading or fatigue stress are known. Accordingly, the present disclosure contemplates food preparation tools and associated handles that can accommodate certain maximum stresses, but also withstand certain stresses when applied in a repetitive manner.

In various embodiments, a handle portion generally comprises a half cylinder structure and the moment of inertia about the longitudinal axis of such an embodiment is characterized by

I=(1/2−16/9π²)*mr²

Embodiments of the present disclosure comprise a user-grasping portion 8 of the handle 10 of sufficient thickness so as to resist deformation due to bending forces. The thickness, or delta between “h₂” and “h₁” in FIG. 4, is preferably at least 0.25 inches. Embodiments comprising a steel handle with a thickness of approximately 0.25 inches and a length of approximately 5.625 have been shown to suitably withstand user-applied loads over time.

Various embodiments contemplate a thickness, or delta between “h₂” and h₁ in FIG. 4, of between approximately 0.0625 inches and approximately 2.0 inches. In preferred embodiments, a handle is provided with a thickness, or delta between “h₂” and “h₁” in FIG. 4, of between approximately 0.125 inches and approximately 0.50 inches.

Various embodiments contemplate a tool that is sufficiently strong to experience elastic but not plastic deformation, metal fatigue, fracture and compressive failure, particularly during repeated uses of the tool to create patties. Stated another way, the tool has sufficient dimensions and is composed of a sufficiently strong material to resist the various types of irreversible deformation in response to the tensile (pulling) and compressive (pushing) forces and the shear, bending and torsion forces, particularly during repeated usages.

As will be appreciated, these forces are the result of application of force to the tool by a user. This force can be all or part of the body weight of the user, depending on the particular manner of using the tool (which can vary user-by-user). A target user weight is commonly 200 pounds or more, more commonly about 225 pounds or more, more commonly about 250 pounds or more, and even more commonly about 275 pounds or more.

To experience only elastic deformation during repeated usages in most applications, the tool is commonly designed to have a tensile strength (or ultimate tensile strength) of at least about 250 GPa, more commonly at least about 300 GPa, more commonly at least about 400 GPa, more commonly at least about 450 GPa, more commonly at least about 500 GPa, more commonly at least about 550 GPa, more commonly of at least about 600 GPa, more commonly of at least about 650 GPa, more commonly of at least about 700 GPa, and even more commonly at least about 750 GPa; a compressive strength of at least about 250 GPa, more commonly at least about 300 GPa, more commonly at least about 400 GPa, more commonly at least about 450 GPa, more commonly at least about 500 GPa, more commonly at least about 550 GPa, more commonly of at least about 600 GPa, more commonly of at least about 650 GPa, more commonly of at least about 700 GPa, and even more commonly at least about 750 GPa; a Young'a modulus of no more than about 225 GPa, more commonly no more than about 200 GPa,; yield strength of at least about 200 GPa, more commonly at least about 250 GPa, more commonly at least about 300 GPa, more commonly at least about 350 GPa, more commonly at least about 400 GPa, more commonly at least about 450 GPa, more commonly of at least about 500 GPa, more commonly of at least about 550 GPa, more commonly of at least about 600 GPa, and even more commonly at least about 650 GPa; an endurance limit of at least about 200 N/mm², more commonly at least about 225 N/mm², more commonly at least about 250 N/mm², more commonly at least about 300 N/mm², more commonly at least about 325 N/mm², more commonly at least about 350 N/mm², more commonly of at least about 375 N/mm², more commonly of at least about 400 N/mm², more commonly of at least about 425 N/mm², and even more commonly at least about 450 N/mm²; and a fraction of endurance limit/tensile strength in the range of from about 0.375 to about 0.650 and more commonly from about 0.4 to about 0.6.

Provided below is a table providing dimensions of various tools 2 according to particular embodiments. It will be recognized that the following embodiments and corresponding dimensions are provided for illustrative purposes only, and no limitation with respect to tool size or proportions is provided or suggested herein. Although various tools provided below have been shown to provide advantages, various alternative embodiments are within the scope and spirit of the present disclosure.

TABLE 1
Exemplary Food Preparation Tools.

| | Corresponding | | | |
|---|---|---|---|---|
| | Patty Size | Length (L) | Width (W) | |
| Tool | (ounces) | (in.) | (in.) | Depth (d) (in.) |
| 1 | 4 | 4.625 | 5.475 | 0.350 |
| 2 | 4.5 | 5.500 | 5.750 | 0.385 |
| 3 | 5.3 | 5.250 | 5.950 | 0.385 |
| 4 | 6.4 | 6.125 | 6.375 | 0.425 |
| 5 | 8 | 6.000 | 6.875 | 0.420 |

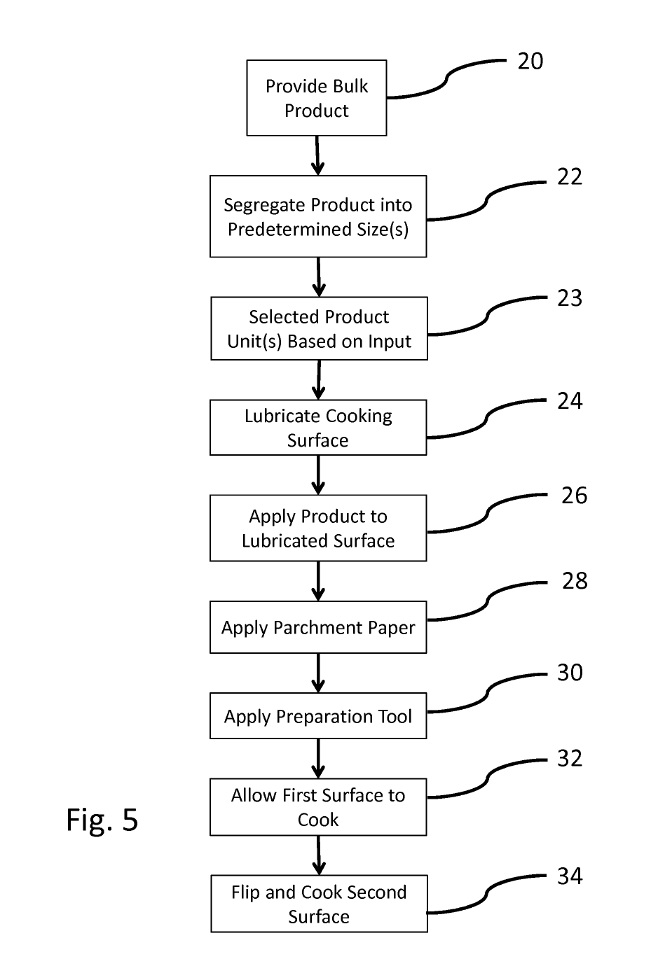

FIG. 5 is a flowchart illustrating a method of food preparation according to one embodiment of the present disclosure. As shown, a method is provided comprising an initial step of providing a quantity of meat or food product 20. Where the product is provided in bulk form, a second process step is contemplated for segregated and/or shaping the product 20 into individual serving sizes 22. Individual serving sizes are contemplated as comprising, but are not limited to, meat balls in ¼, ⅓, and ½ pound sizes. Upon receipt of an input 23, such an indication of customer order or request, the appropriate sized serving size corresponding to that request is selected from, for example, a refrigerated storage area. Preferably, a flavoring and/or lubricating element such as butter or cooking oil is applied 24 to a heated surface, such as a grill or griddle and the serving size portion is placed on the treated area 26. A piece of parchment, wax paper, or similar is applied 28 on top of the portion, and a food processing tool is applied 30 to shape and apply force to the portion. Providing such force deforms the portion to a desired size and thickness, and in combination with the butter or oil, creates a sear on at least one side of the food product. This sear promotes cooking efficiency in accordance with the present disclosure and provides various benefits. The product is allowed to cook 32 for a predetermined time corresponding to the specific size of the product. It will be recognized that larger sized portions may require longer cooking times. The processing tool is removed either during or at the expiration of the cook time 32. Subsequent to the first cook time 32, the product is flipped such that upward and downward planar sides are reversed. The second side 34 is allowed to cook, either with or without the presence of the tool. In preferred embodiments, the second side is allowed to cook without the presence of the tool. The second side is allowed to cook for a predetermined amount of time and the product is then removed from the heating/cooking surface. Various subsequent operations are further contemplated, including providing the product on a bun, applying cheese to the product either before or after the product is removed from the heat source.

A number of variations and modifications of the disclosure can be used. It would be possible to provide for some features of the disclosure without providing others. The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An apparatus for handling food product, the apparatus comprising:
a body portion comprising a substantially planar member having a predetermined outer shape;
at least one sidewall portion extending from a lower surface of the substantially planar member and provided substantially perpendicular to the substantially planar member;
a handle portion comprising at least one support member extending from an upper surface of the substantially planar member and provided substantially perpendicular to the substantially planar member;
the handle portion comprising a user-interface portion interconnected to the at least one support member, the user-interface portion having a length, a width, a thickness and a cross-sectional shape;
the length comprising a length of at least about 4.00 inches;
the width comprising a width of at least about 1.00 inches;
the thickness comprising a thickness of at least about 0.10 inches;
wherein an enclosed volume is formed by the substantially planar member and the at least one sidewall portion when a lower portion of the sidewall portion is brought into contact with a substantially flat surface.

2. The apparatus of claim 1, wherein the predetermined outer shape is circular.

3. The apparatus of claim 1, wherein the predetermined shape comprises a curvilinear shape with multiple points of inflection and which is asymmetric about at least one axis.

4. The apparatus of claim 1, wherein the at least one sidewall portion extends along the entirety of a perimeter of the substantially planar member.

5. The apparatus of claim 1, wherein at least two support members extend from the upper surface of the substantially planar member and the user-interface portion comprises a beam member disposed substantially perpendicular to the at least two support members.

6. The apparatus of claim 1, wherein the enclosed volume comprises a volume between approximately 6.5 cubic inches and approximately 14 cubic inches.

7. The apparatus of claim 1, wherein the cross-sectional shape of the user-interface portion is a semi-circular shape.

8. The apparatus of claim 1, where the thickness comprises a thickness of approximately 0.35 inches.

9. An apparatus for handling a food product during a cooking operation, the apparatus comprising:
a body portion comprising a substantially flat portion and at least one sidewall extending substantially perpendicularly therefrom;
wherein the at least one sidewall comprises a first end and a second end, the first end interconnected to the substantially flat portion and the second comprising a free end for contacting a surface, wherein the distance between the first end and the second is substantially constant over the entire perimeter of the at least one sidewall;
wherein the second end of the at least one sidewall is adapted to contact a substantially planar surface such that when the entire perimeter of the at least one sidewall contacts the substantially planar surface the substantially flat portion and the substantially planar surface are positioned in parallel planes;
a handle portion in force-transmitting communication with the substantially flat portion;
the handle portion comprising an elongate member having a length of at least about 4.00 inches, a width of at least about 1.00 inches, a thickness of at least about 0.25 inches and a cross-sectional shape;
wherein a void space is provided within the at least one sidewall and defined on at least one side by the substantially flat portion.

10. The apparatus of claim 9, wherein a perimeter of the body portion is circular.

11. The apparatus of claim 9, wherein a perimeter of the body portion comprises a curvilinear shape with multiple points of inflection and which is asymmetric about at least one axis.

12. The apparatus of claim 9, wherein the at least one sidewall portion extends along the entirety of a perimeter of the substantially flat portion.

13. The apparatus of claim 9, wherein at least two support members extend from the upper surface of the substantially flat portion and the handle portion comprises a beam member disposed substantially perpendicular to the at least two support members.

14. The apparatus of claim 9, wherein the void space comprises a volume between approximately 6.5 cubic inches and approximately 14 cubic inches.

15. The apparatus of claim 9, wherein the cross-sectional shape comprises is a semi-circular shape.

16. A method of preparing a food product, the method comprising:
forming a plurality of food product units from a source, each of said plurality of food product units comprising at least one of a predetermined volume and a predetermined weight;
based on an input request, selecting at least one of the plurality of food product units;
applying at least one of a flavoring and a lubricating substance on an area of a heated surface;
placing said at least one of the plurality of food product units on the area;
providing an apparatus for handling food product, the apparatus comprising a body portion comprising a substantially planar member having a predetermined outer shape, at least one sidewall portion extending from a lower surface of the substantially planar member and provided substantially perpendicular to the substantially planar member, a handle portion comprising at least one support member extending from an upper surface of the substantially planar member and provided substantially perpendicular to the substantially planar member, the handle portion comprising a user-interface portion interconnected to the at least one support member, the user-interface portion having a length, a width, a thickness and a cross-sectional shape;
placing the apparatus in contact with the at least one of the plurality of food product units;
applying a force to the handle portion and deforming the at least one of the plurality of food product units until the food product unit contacts substantially the entirety of the planar member and the at least one sidewall portion;
allowing a first amount of time to lapse;
rotating the at least one of the plurality of food product units approximately 180 degrees;
allowing a second amount of time to elapse; and
removing the at least one of the plurality of food product units from the area.

17. The method of claim 16, further comprising providing a layer of parchment paper on the at least one of the plurality of food product units prior to placing the apparatus in contact with the at least one of the plurality of food product units.

18. The method of claim 16, wherein the first amount of time not more than two minutes.

19. The method of claim 16, wherein the first amount of time not more than two minutes.

20. The method of claim 16, wherein the plurality of food product units comprises a plurality of ground beef portions of single-serving size.
